(19) United States
(12) Patent Application Publication
(10) Pub. No.: US 2007/0130067 A1
(43) Pub. Date: Jun. 7, 2007

(54) System and method for notification of transmission and service costs of using telecommunication network

(76) Inventor: Walter Keller, Ratingen (DE)

Correspondence Address: GORDON & REES LLP, 101 WEST BROADWAY, SUITE 1600, SAN DIEGO, CA, 92101, US

(21) Appl. No.: 11/591,949

(22) Filed: Nov. 2, 2006

Related U.S. Application Data
(63) Continuation of application No. 09/890,554, filed on Aug. 2, 2001, now abandoned.

(30) Foreign Application Priority Data
Aug. 20, 1999 (DE) DE 199 39 151.3
Aug. 18, 2000 (DE) PCT/DE00/02836

(51) Int. Cl. G06Q 40/00

(52) U.S. Cl. 705/40; 370/395.52

(57) ABSTRACT

The aim of the invention is to permanently and preventively display the complete transmission and service costs of internet, online and telecommunication services that are offered by corresponding service providers (telecommunications internet and/or data service provider T/DSP) during use of said services. To this end, the costs are recorded and calculated by the T/DSP and are then transmitted to the user. The T/DSP is linked with the data banks of the companies by means of automatic data exchange so as to detect all relevant costs, such as the telecommunication transmission costs, own link-oriented or volume-oriented costs as well as the costs for using services and optionally costs for service offers of third parties that market their services to the user via the T/DSP. These relevant costs for the respective connection are recorded and stored in said data banks. The T/DSP relevant costs are automatically transmitted from the above-mentioned data banks during a projected connection (session). They are transmitted upon an automatic inquiry by the T/DSP or on the basis of the limited access authorization of the T/DSP to the corresponding data.

The invention relates to a method for notifying a user's transmission and service costs of using telecommunications systems, especially for packet-oriented data transmission and for Internet and online data, according to the preamble of patent claim 1.

Currently, the most frequently-used application for data transmission methods is the use of online and Internet services.

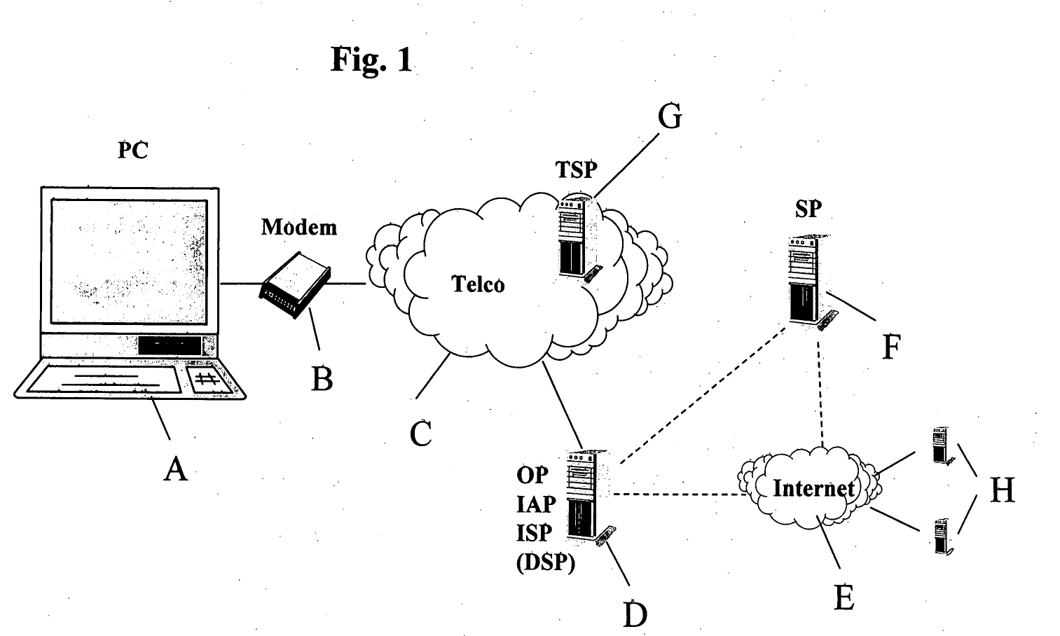

The convention procedural method, at least in the Federal Republic of Germany, for online and Internet access is shown in FIG. 1. A user is connected with his personal computer (A) by means of modem (B) to a telecommunication system (C), e.g., the analog telephone system or the ISDN network. In this way, he sets up a dialed connection to the Internet Access Provider (IAP), to the Internet Service Provider (ISP) or to the Online Provider (OP) involved (D). The difference between these service agencies consist in that the IAP only sets up the network interface between the telecommunication system and the public Internet (E), while the ISP offers Internet services itself. This means that it is possible e.g., to reach any ISP by way of the user's IAP. In practice, the relationships become intermingled so that many IAPs also offer services. An OP offers online services, i.e., data services in direct access. That does not necessarily have to be services on the basis of Internet protocol. For example, for many years T-Online offered screen text services (Btx) and achieved its current popularity even before the Internet. The term OP has become established, even if today more and more services are being offered with Internet protocol structure.

For the purpose of simplification, these terms are summarized here with the term Data Services Provider (DSP), which in the following indicates a service provider that is both an Internet access for users that are connected to the telecommunication system, as well as possibly also offering services of their own, e.g., e-mail accounts, Internet presentations for users, banking transactions, weather forecasts, news services, discussion forums, merchandise for sales, etc. Generally these services are not designed so that they have all the contents themselves, rather there are business relationships to contract partners (service or content provider S/CP), like banks, warehouses, news services, etc.

The task of the DSP exists mainly in the network service situation between the provider (F, H) and user (A). To do this EDP interfaces and transmission protocols that have been agreed upon, fast line connections and especially a representative presentation of the accesses to the companies within a title page (portal) or e.g., a card or database of the DSP are necessary so that the users find this access as easily as possible and can use what is offered.

There may also be payment terms, according to which a statement of accounts for S/CP services is given by way of the DSP invoice, e.g., for the T-Online services (formerly Btx area). Also in some cases contractual relationships exist between telecommunication system operators and DSP, e.g., as between Telekom and T-Online, wherein separate invoicing is not done by T-Online, rather the T-Online costs are invoiced on the monthly long distance bill.

Further it can be assumed that, in the future, telecommunication system operators will offer their own data services to their customers, whereby this can also be carried out e.g., with support from S/CP. For example, such methods can be found in the GSM mobile communications area. Reference is made here to “The GSM System for Mobile Communications,” Cell & Sysy Verlag, Palaiseau/France ISBN 2-9507190-0-7, which describes that services will increasingly be provided using Short Message Service, SMS, but in the future also preferably using General Packet Radio Service, a standardized packet service on the basis of Internet protocol; see also “Digital Cellular Telecommunications System” (Phase 2+), General Packet Radio Service, ETSI Draft EN 301 113.

Currently, all the methods used have the disadvantage that because of the not-insignificant cost structure among several participating companies (telecommunication system, DSP, S/CP) and complicated rate structures in each case, no ongoing cost control by the user is possible. In each case, he can only learn after the fact, at the end of an invoicing period (usually monthly) what costs he has incurred.

Therefore an improvement in the situation is desirable, by the introduction of an automatic method to determine and display the current total costs.

The present invention is based on the task of suggesting a method, on the basis of which a data service user of Internet, telecommunication and online services can be at provided with information on transmission costs both during a session and as a preventive measure before an upcoming transmission of large data quantities.

This task is solved by the characterizing features of patent claim 1.

The invention is based on the fact that the service provider continuously determines the total costs accrued during a connection in progress using access to its own fee database and access to comparable facilities of the service or content suppliers participating in the connection and of the telecommunication and transmission systems used and transmits it on request or automatically to the user's terminal.

The fee data are managed in the fee database, i.e., all the user-specific and the service-specific fee terms are stored, as well as the user-specific contract data (prices, bonuses, subscriptions, blocks, etc.).

According to one embodiment of the invention, as one alternative access by the service provider to the fee databases of the participating organizations can occur automatically by direct reporting of the percentage of costs incurred from the organizations as a response to a specific inquiry by the service provider at the start of each connection. In this process, the percentage of costs incurred from the participating organizations are preferably updated automatically.

Alternatively, an automatic access by the service provider to the corresponding data records of the participating organizations' databases can be carried out. The data access, as well as the transferred data, are preferably protected against misuse by using suitable means.

Another embodiment provides that the fee data to be transmitted to the terminal by the service provider can optionally be configured using configuration on the part of the user in type and scope of delivery, whereby e.g., an automatic, continuously updated delivery can be carried out of only the fee total or e.g., all of the individual fee records. Optionally, a consideration of the fee data in the service provider database by the user without automatic delivery can be carried out, whereby the configuration option on the part of the user is preferably protected against misuse using suitable means.

If necessary, a subsequent processing of the fee data can advantageously be carried out in the user's terminal, whereby e.g., different display formats and degrees of detail can be shown.

For simple use of the method according to the invention, a terminal software part (client) is provided that works together with the T/DSP fee database and is installed directly within the access or browser software.

Another embodiment of the invention provides that optionally a transfer by the service provider of specially marked forecast data (quoted costs) is carried out for the pending cost-intensive service or transmission offerings, which is carried out by determining the service and/or transmission costs involved in cooperation with the organizations and telecommunications systems involved, whereby optionally an activation by the user (order) or a rejection of the service provider and/or the transmission can occur. In this way, the user can be informed of the forecast costs even before use of a service or before a data transmission.

In order to save transmission costs that depend on the time of day, the user can optionally request usage of services and/or transmissions alternatively at a later time by using additional terminal menu items, at which time usage is more economical, which occurs because of automatic activation by the terminal or alternatively, by the service provider e.g., a download of very large files at the night rate.

In this context, the invention also provides that the user can optionally also initiate an immediate transmission of the data requested from a remote Internet service provider to the service provider, whereby the data transmission (downloading or uploading) of the data involved can be carried out separately between the service provider and terminal, which is then especially advantageous if the user has an expensive telecommunication line to the service provider and transmission bottlenecks are present on the Internet so that the cost-intensive telecommunication line can be used more economically in a burst-like transmission between service provider and terminal.

In the following, the invention will be explained using drawings, which describe only one possible embodiment using an Internet transmission and a PC as terminal as an example, whereby other characteristics, applications and advantages of the invention can be seen in the drawings.

FIG. 1: shows a typical Internet connection (state of the art);

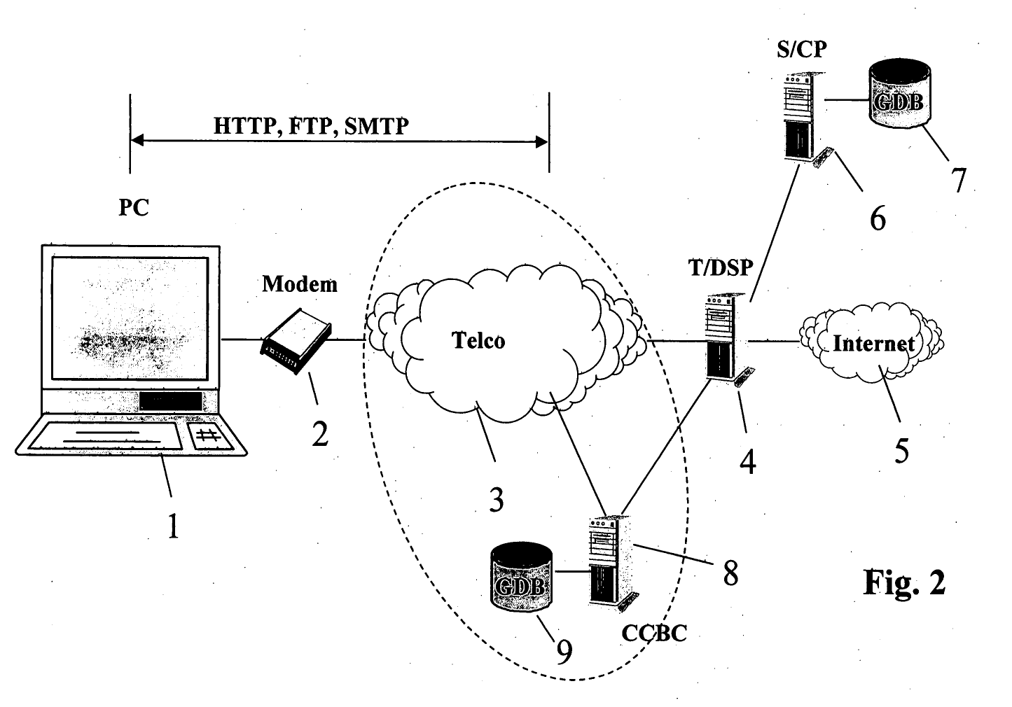

FIG. 2: shows an Internet connection with expansion according to the invention for displaying costs;

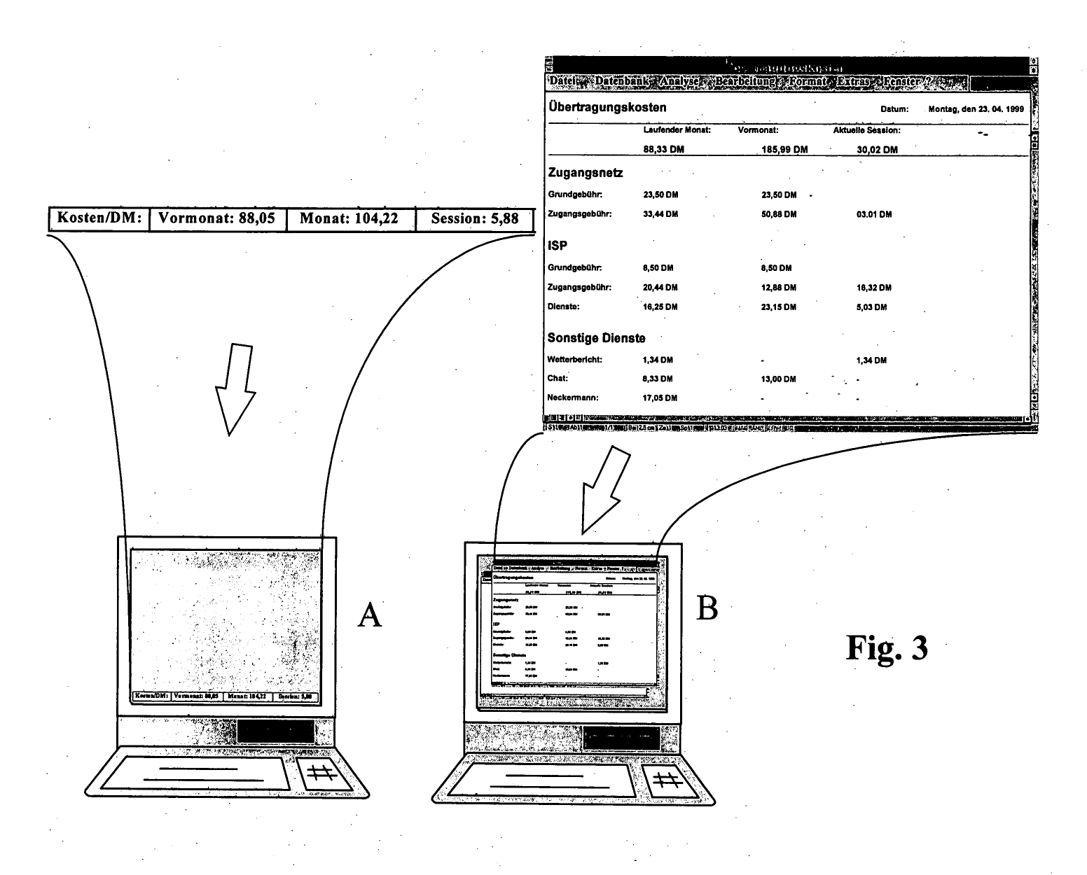

FIG. 3: shows an example of two different display types for the connection costs.

FIG. 1 relates to the representation of a typical Internet connection and was already explained above.

FIG. 2 shows the principle of the method according to the invention. The user is connected in the conventional way with his terminal 1 by way of a modem 2 to the telecommunication system 3 and thereby produces a connection with his service provider. In this process it is unimportant whether the method is used for a telecommunication service provider (TSP) within a telecommunication system as service provider, or a data service provider (DSP) connected to a telecommunication system. Both service providers 4 are therefore combined in the schematic illustration with the identification (T/DSP).

Because of the protocol connection used, generally there is an end-to-end connection between the user's terminal 1, depending on the network a PC, a mobile communication device, etc. and the service provider 4.

According to the invention, the service provider 4 determines the current total costs of a connection, e.g., Internet connection and transmits them to the user, where they can be displayed in a convenient format, preferably on terminal 1.

To do this, the service provider 4 has connections to the fee databases of its participating service and content providers 6 (S/CP), whereby the corresponding fee information is alternatively transmitted automatically by the service and content provider 6, automatically requested by service provider 4 or automatically determined with limited S/CP access permission to the respective memory items in the S/CP fee database 7. In addition, service provider 4 has a connection to the fee database 9 of telecommunication system 3, which is shown schematically here using access to the Customer Care and Billing Center 8 (CCBS) with connected database 9 as an example. Depending on the preferred method and technical equipment, the automatic transmission of the current fees (e.g., fee pulses) to the service provider 4 is possible, it then being possible to process the fees there as needed, or there is a transmission of higher-quality information, e.g., the transmission of total connection costs. Optionally, for complete notification of the total costs by the service provider 4, a base fee, previously accumulated monthly fees and other useful data can be transmitted. Alternatively to this method, service provider 4 has a limited access to the fee database 9 of telecommunication system 3 and, by reviewing the contract data between telecommunication system 3 and user, determines the necessary value automatically for users who require the actual costs for calculation, in addition to the fee pulse.

Then alternatively an automatic transmission of the fee data to the user's terminal 1, which preferably is continuously updated to the current fee status, is repeated, or the information is held in a file that is continuously updated so that it is available to be viewed by the user. In this context, it is advantageous if the fee status is also continuously updated during viewing by the user, whereby there is an option for the user, e.g., when working with window-oriented graphical screen interfaces, to open a corresponding fee window and leave it open over a fairly long period of time. In this process, each time the fee is updated, the service provider automatically transmits the updated status to the user.

Preferably different displays can be shown separately in this way, e.g., total costs to date in the invoicing period (e.g., monthly) and costs of the current session. Also e.g., an optional warning is possible at a preset highest limit (monthly limit).

Determination of cost information as a preventive measure for upcoming data transmissions from a third party, e.g., File Transport Protocol files (FTP files) from remote ISP using the Internet access of service provider 4, whereby because of the typical end-to-end connection on the Internet 5, service provider 4 has no influence on the contents of this connection, is carried out by a cost inquiry on the part of the user to the service provider, whereby he e.g., transmits the data volume for the upcoming transmission to data provider 4 either automatically or using an automatic procedure that uses a corresponding inquiry template and the service provider can calculate, at least, a forecast of its own cost portion and the telecommunication system costs for the transfer service.

FIG. 3 presents display types that are different in principle, as an example. While version A offers continuous cost information in brief form, using a screen display in an exposed location, or e.g., a display in an appropriate position of the Internet browser or the online access software, in version B an independent window of the graphical user interface is used for display, whereby in this case optionally more information can be displayed, e.g., an individual voucher. A linking of both methods in a way such that during selection and activation of the brief display, a separate cost information window with expanded information is opened is also possible.

Determining costs as a preventive measure before an upcoming transmission is possible in the case where information on the upcoming data scope is available. This is frequently the case, especially with FTP communication, if e.g., a download file with information on the data quantity is available.

Optionally, an additional operations menu can be displayed, which makes possible activation of different transmission options, like a later cost-effective automatic transmission, e.g., in POP operation (PC automatically initiates the connection) or e.g., an intermediate solution with immediate transmission by a remote ISP to the service provider with temporary intermediate storage and later transmission by way of the telecommunication system.

1-15. (canceled)

16. A method for notifying a user of transmission and service costs of using telecommunication systems for communication connections, packet-oriented data transmission, and for Internet and online data,
wherein a service provider determines fee information based on total costs incurred during a connection, by accessing fee databases of the service provider and other service agencies involved, the other service agencies comprising service and content suppliers and telecommunication and transmission systems, and transmits the fee information, on request or automatically, to a terminal of the user; and
wherein access by the service provider to the fee databases of the service agencies involved is carried out either automatically, by direct transmission of the portion of the costs incurred by the service agencies involved, or as a response to a specific inquiry by the user at the start of the connection.

17. The method as claimed in claim 16, wherein fee data management is carried out in the fee databases and all user-specific and service-specific fee terms and user-specific contract data are stored.

18. The method as claimed in claim 16, wherein the service provider automatically accesses corresponding data records assigned to respective fee databases of the service agencies involved.

19. The method as claimed in claim 16, wherein the portion of the costs incurred are updated by the service agencies involved.

20. The method as claimed in claim 19, wherein the portion of the costs incurred are updated automatically.

21. The method as claimed in claim 16, wherein data access to the databases and the data transmitted are protected against misuse.

22. The method as in claim 16, wherein the user has the option of configuring the type and scope of the delivery of the fee information to be transferred by the service provider to the user's terminal.

23. The method as claimed in claim 16, wherein the service provider automatically transmits an updated status to the user whenever a fee is updated.

24. The method as claimed in claim 16, wherein the fee information is held in a file that is available for viewing by the user in the fee database of the service provider.

25. The method as claimed in claim 16, wherein the fee information is prepared for display to the user on the user's terminal in different display formats, the formats comprising at least one less-detailed display and one more-detailed display.

26. The method as claimed in claim 16, wherein a software that works directly with the service provider's database is provided within the access or browser software at the user's terminal.

27. The method as claimed in claim 16, wherein the user can use additional menu items at the terminal to request usage of services and/or transmissions at a later point in time, at which time usage is more economical, and wherein automatic activation of the service and/or transmission occurs by automatic activation by the terminal or by the service provider.

28. A method of notifying a user of transmission and service costs of using telecommunication systems for communications connections, packet-oriented data transmission, and for Internet and online data, wherein
a service provider determines fee information based on total costs incurred during a connection by accessing fee databases of the service provider and other service agencies involved, the other service agencies comprising service and content suppliers and telecommunication and transmission systems, and transmits the fee information, on request or automatically, to a terminal of the user, and wherein
the service provider transmits a forecast of cost for upcoming cost-intensive service or transmission offerings in response to a cost inquiry on the part of the user, the service provider determining the estimated service and/or transmission costs involved in cooperation with connected service agencies.

29. A method of notifying a user of transmission and service costs of using telecommunication systems for communication connections, packet-oriented data transmission; and for Internet and online data, wherein
a service provider determines fee information on total costs incurred during a connection by accessing fee databases of the service provider and other service agencies involved, the service agencies comprising service and contract suppliers and telecommunication and transmission systems, and transmits the fee information, on request or automatically, to a terminal of the user, and the user can initiate an immediate transmission of data offered by a remote Internet service provider to the service provider, the transmission of the data between the service provider and the terminal occurring at a later time.
